(19) United States
(12) Patent Application Publication
(10) Pub. No.: US 2025/0015395 A1
(43) Pub. Date: Jan. 9, 2025

(54) AQUEOUS ZN||NO2 ELECTROCHEMICAL CELL

(71) Applicant: City University of Hong Kong, Hong Kong (HK)

(72) Inventors: Chunyi ZHI, Hong Kong (HK); Longtao MA, Hong Kong (HK)

(21) Appl. No.: 18/346,852

(22) Filed: Jul. 4, 2023

(51) Int. Cl. H01M 12/08; C25B 1/27; C25B 9/23; H01M 4/38; H01M 4/88; H01M 4/90

(52) U.S. Cl. CPC H01M 12/08; C25B 1/27; C25B 9/23; H01M 4/38; H01M 4/8807; H01M 4/9016; H01M 2300/0002

(57) ABSTRACT

The present invention relates to an electrochemical cell based on an aqueous Zn∥NO₂ system with a nano-NiO catalyst deposited as gas diffusion cathode, a metallic Zn foil as anode and a ZnCl₂ aqueous solution as electrolyte. Importantly, the electrolyte can efficiently capture NO₂, then convert it to NO₂ and eventually to the value-added NH₃, while simultaneously producing electric power. The obtained electrochemical cell exhibits bifunctional activity and stability (>100 h) towards reversible NO₂ reduction and evolution reactions. A high cell-level energy density of 553.2 Wh·kg⁻¹_{cell}/1589.6 Wh·L⁻¹_{cell} from pouch cells (2.4 Ah) has been achieved. As an additional green feature, the produced NO₂⁻ by the Zn∥NO₂ cell is subsequently converted to NH₃ by a self-power mechanism, thereby servicing multiple key conversion steps in the nitrogen cycle all within a single device, paving the way to scalable, highly integrated solutions.

### FIELD OF THE INVENTION

The present invention generally relates to the field of electrochemistry or energy storage. More specifically, the present invention provides a high-energy aqueous Zn∥NO₂ electrochemical cell.

### BACKGROUND OF THE INVENTION

The ever-increasing worldwide energy demand and the emission of industrial waste gases and vehicle exhaust (e.g., NO₂, NO, SO₂, CO₂, CO) resulting from the massive combustion of fossil fuels necessitate the development of effective technologies for capturing exhaust gases and converting them into electricity. Among these gases, NO₂ released into the atmosphere contributes to photochemical smog, stratospheric ozone deterioration and global warming, leading to significant environmental and health concerns. Therefore, there is an urgent need for a strategy to convert NO₂, alleviating NO₂ accumulation and simultaneously produce value-added chemicals, such as NH₃.

A variety of metal∥gas electrochemical cells, such as Li∥CO₂, Li∥SO₂, Al∥CO₂, Zn∥CO₂ systems, have been proposed as novel approaches to capture exhaust gas streams while providing the additional benefit of electrical energy production¹⁻⁶. In the case of NO₂ gas, a Li∥NO₂ battery has been reported to reduce NO₂⁷. However, the Li∥NO₂ cell produces NO as the final reduzate, which itself is another air pollutant⁸⁻⁹. Currently, there is no electrochemical method available to capture and utilize exhausted NO₂ for value-added chemicals, while simultaneously generating electrical power.

### SUMMARY OF THE INVENTION

In a first aspect, the present invention provides a rechargeable aqueous Zn∥NO₂ cell, which includes an anode, a gas diffusion cathode formed by at least one nano NiO catalyst-deposited material and located under a gas source, a separator placed between the gas diffusion cathode and the anode, and an electrolyte disposed in a space between the gas diffusion cathode and the anode. The rechargeable aqueous Zn∥NO₂ cell delivers a high specific capacity of at least 800 mAh·g⁻¹ with an output voltage of 1.79 V at 0.2 mA·cm⁻², and when the current increased up to 20 mA·cm⁻², the rechargeable aqueous Zn∥NO₂ cell delivers a high capacity of at least 700 mAh·g⁻¹ with at least 90% capacity retention.

In accordance with one embodiment, the nano-NiO catalyst exhibits an electrocatalytic performance of at least 350 mV for overpotential at 10 mA·cm⁻², and the nano-NiO catalyst exhibits a Tafel slope lower than 65 mV·dec⁻¹.

In accordance with one embodiment, the anode includes Zn foil or Zn plate.

In accordance with one embodiment, the electrolyte includes ZnCl₂ solution, Zn(OTf)₂ solution, ZnSO₄ solution, or KOH solution, or a combination thereof.

In accordance with one embodiment, the separator includes polypropylene/polyethylene/polypropylene (PP/PE/PP) separator, poly(tetrafluoroethylene) (PTFE), poly(vinyl chloride) (PVC) and polyamide (PA).

In accordance with one embodiment, the at least one nano NiO catalyst-deposited material comprises carbon fiber cloth (CFC), fluorocarbon-based polymer (e.g., Nafion™), or isopropanol.

In accordance with one embodiment, a device having the nano NiO catalyst exhibits a high open circuit voltage (OCV) of at least 1.8 V under NO₂ atmosphere.

In accordance with one embodiment, the rechargeable aqueous Zn∥NO₂ cell has a peak power density of at least 80 mW·cm⁻².

In accordance with one embodiment, the gas source is NO₂. The rechargeable aqueous Zn∥NO₂ cell works with at least 3 vol. % NO₂ gas diffusing. The gas diffusion cathode is based on the NO₂/NO₂⁻ redox reaction.

In accordance with one embodiment, the rechargeable aqueous Zn∥NO₂ cell is of Ah-scale.

In accordance with one embodiment, the rechargeable aqueous Zn∥NO₂ cell delivers a high energy density of at least 553.2 Wh·kg⁻¹_{cell} and a high volumetric density of 1589.6 Wh·L⁻¹_{cell}.

In accordance with another embodiment, the rechargeable aqueous Zn∥NO₂ cell demonstrates cycling stability over 100 h at a current density of 5 mA·cm⁻² with a charge or discharge time of 1 h, and the energy efficiency reaches at least 80%.

More preferably, the present invention provides a 1.8 V, 2.4-Ah-scale aqueous Zn∥NO₂ electrochemical system. This system utilizes a 3 vol. % NO₂/air mixture as an energy carrier to store renewable energy, which exhibits ultrahigh cell level energy density of 553.2 Wh·kg⁻¹_{cell} and volumetric energy density of 1589.6 Wh·L⁻¹_{cell}. The Zn∥NO₂ cells effectively capture NO₂ and convert NO₂ to NO₂⁻ species at room temperature. The Faradaic efficiency of NO₂→NO₂⁻ reaches 96.4%. The produced NO₂⁻ can be further converted to NH₃ using an electrochemical Haber-Bosch reactor, self-powered by the Zn∥NO₂ cells.

In accordance with another aspect of the present invention, the present invention provides a self-powered Haber-Bosch reactor for NH₃ production. The reactor includes a graphite bipolar plate, an ion exchange membrane, a TiO₂/CFC electrode, and at least two rechargeable aqueous Zn∥NO₂ cells connected in series to drive the subsequent electrocatalytic reduction for NH₃ synthesis.

With the duration extended, the voltage maintains 3.0 V unchanged and the output current is approximately 2.1 mA·cm⁻² over 8 h. The self-powered Haber-Bosch reactor has a self-powered NH₃ yield of at least 4 mM·h⁻¹ per hour by measuring solution volume involved in the cathode reaction.

### BRIEF DESCRIPTION OF THE DRAWINGS

Embodiments of the present invention are described in more detail hereinafter with reference to the drawings, in which:

FIG. 1a shows a schematic diagram of Zn∥NO₂ electrochemical cell. FIG. 1b shows architectures of Zn∥NO₂ electrochemistry technology as a capture system;

FIG. 2 depicts total and partial density of states (DOS) for NO₂ adsorbed on NiO, CoO, CuO, and FeO;

FIG. 3 shows structures of NO₂ adsorption configuration 1 and configuration 2 on NiO, CuO, FeO and CuO surfaces. The charge transfers from NiO, CoO, FeO and CuO surface to *NO₂;

FIG. 4a shows 2D contour plot of CDDD of adsorbed *NO₂ on NiO, CoO, FeO and CuO. FIG. 4b shows Gibbs free energy diagrams for NO₂⁻↔NO₂ conversion on NiO, CoO, FeO, and CuO surface. FIG. 4c shows the galvanostatic charge/discharge curves of the Zn/NO₂ electrochemical cell at a current density of 2 mA·cm⁻² with commercial Pt/C, CuO, FeO, CoO, NiO and nano-NiO electrocatalysts. FIG. 4d shows XRD pattern of nano-NiO and the corresponding results of the Rietveld refinement. FIG. 4e shows TEM image of nano-NiO;

FIG. 5 shows the charge density difference distribution (CDDD) of adsorbed *NO₂ on NiO, CoO, FeO, and CuO with the isosurface value of 0.005 e Bohr⁻³;

FIG. 6a shows NO₂ reduction reaction polarization curves of the commercial Pt/C, CuO, FeO, CoO, NiO and nano-NiO electrodes at a scan rate of 5 mV·s⁻¹ in 2M ZnCl₂ aqueous solution, and FIG. 6b shows corresponding Tafel plots of these catalysts. FIG. 6c shows NO₂ reduction reaction polarization curves of the nano-NiO electrodes at 5 mV·s⁻¹ in different aqueous solutions, and FIG. 6d shows corresponding Tafel plots. FIG. 6e shows SEM images of nano-NiO;

FIG. 7a depicts open circuit voltage of the Zn∥NO₂ electrochemical cell with NiO and nano-NiO catalysts over 50 h. FIG. 7b depicts the discharged polarization profile and corresponding power densities curves at different densities. FIG. 7c depicts charge-discharge polarization profiles at different current densities. FIG. 7d depicts full discharged profiles recorded at different current densities of 0.2, 1, 5, 10 mA·cm⁻². FIG. 7e depicts cycling performance testing at 2 mA·cm⁻² using nano-NiO catalyst. FIG. 7f depicts the discharge curves of Zn∥NO₂ electrochemical cells at different discharge current densities. FIG. 7g depicts Energy efficiency of the Zn∥NO₂ electrochemical cell with 3 vol. % NO₂ at 10 mA·cm²;

FIG. 8 depicts the AC impedance to examine ionic conductivity of 2M ZnCl₂ aqueous electrolyte;

FIG. 9 depicts full discharged profiles recorded at current densities of 1 mA·cm⁻² with 3 vol. % NO₂/Ar and 3 vol. % NO₂/Air diffused;

FIG. 10 depicts the XRD patterns of nano-NiO before and after cyclic test;

FIG. 11 depicts the home-made operando pH detection configuration, and discharge-charge curves of first cycle recorded at 2 mA·cm⁻² over 2 h for one cycle, and corresponding discharged/charged times dependence of pH changes during cycling;

FIG. 12a shows schematic illustration of rechargeable aqueous Zn∥NO₂ pouch cell with cathode-anode-cathode stack structure and an optical photograph of rechargeable aqueous Zn∥NO₂ pouch cell. FIG. 12b shows the delivered cell capacities of NO₂∥Zn∥NO₂ cells at different rates of 0.2 and 5 mA·cm⁻². FIG. 12c shows Ragone plots for projected cell-level specific (Wh·kg⁻¹_{(cell)}) and volumetric (Wh·L⁻¹) energy densities with representative commercial and reported batteries. FIG. 12d shows galvanostatic cyclic charge/discharge performance of NO₂∥Zn∥NO₂ cell at a current density of 5 mA·cm⁻²;

FIG. 13 shows a pie chart depicting the optimal weight distribution in cell component at 553.2 Wh·kg⁻¹_{(cell)} specific energy;

FIG. 14a depicts the galvanostatic discharge profile of a Zn∥NO₂ electrochemical cell at different current density. FIG. 14b depicts corresponding NO₂⁻ species yield rates and faradaic efficiencies (FE). FIG. 14c depicts the galvanostatic discharged profile of a Zn∥NO₂ electrochemical cell over different discharging time, and FIG. 14d depicts corresponding NO₂ species yield rates and FE. FIG. 14e depicts discharge-charge curves of first, second and third cycles recorded at 2 mA·cm⁻² over 2 h for one cycle, and discharged/charged times dependence of the NO₂⁻, NO₃⁻, NO₂, NO, O₂ yield during cycling;

FIG. 15a depicts the UV-Vis absorption spectra and FIG. 15b depicts standard calibration curve for different concentrations of NO₂⁻ ions;

FIG. 16a depicts the UV-vis absorption spectra to determine the yield of NO₂⁻ by aqueous Zn∥NO₂ electrochemical cell at different current density, and FIG. 16b over different discharging time;

FIG. 17 depicts comparison of Gibbs free energy diagrams for NO₂⁻—*NO₂ conversion and ORR (pH=5, 7) on NiO;

FIG. 18a depicts the charge/discharge curves of a Zn∥NO₂ electrochemical cell, and FIG. 18b depicts the corresponding ex-situ XRD patterns of NiO-deposited gas diffusion electrode. FIG. 18c depicts Ni K-edge XANES spectra, and FIG. 18d depicts fourier-transformed EXAFS spectra collected at the Ni K-edge of nano-NiO composite obtained ex-situ at different discharged states. FIG. 18e depicts Ni K-edge XANES spectra and FIG. 18f depicts fourier-transformed EXAFS spectra collected at the Ni K-edge of nano-NiO composite obtained ex-situ at different charged states;

FIG. 19a and FIG. 19b depict high-resolution Ni 2p and O 1s spectra of nano-NiO at initial, FIG. 19c and FIG. 19d depict the discharged states, and FIG. 19e and FIG. 19f depict the charged states;

FIG. 20a depicts a schematic of two Zn∥NO₂ electrochemical cells powered electrochemical Haber-Bosch reactor coupled to a water splitting reactor. FIG. 20b shows the corresponding photograph depicting the model. FIG. 20c depicts the voltage and current of electrochemical Haber-Bosch reactor. FIG. 20d depicts the NH₃—H₂O yield rates and FE;

FIG. 21a depicts the UV-Vis absorption spectra and FIG. 21b depicts concentration-absorbance standard calibration curve using the indophenol blue method for different concentrations of NH₄⁺ ions; and

FIG. 22 depicts the UV-vis absorption spectra to determine the yield of NH₄⁺ by self-power conversion system over different discharging time.

### DETAILED DESCRIPTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variation and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

Air pollution resulting from nitrogen oxides (NO₂) in exhausted gases is a long-standing issue, demanding the advancement of novel technologies for capture and abatement. One proposed solution is the utilization of Li∥NO₂ battery to reduce NO₂.

Zinc (Zn) metal is an attractive anode material in aqueous batteries due to its desirable characteristics such as high theoretical capacity (820 mAh·g⁻¹), low redox potential (−0.76 V vs. SHE), low cost, abundant reserves, and suitable reactivity. Coupling the Zn anode with an NO₂ gas diffusion electrode, the device is capable of electrochemically capturing and converting NO₂ through the following overall reaction:

Zn+2NO₂→Zn(NO₂)₂ E⁰=1.85 V (vs. Zn/Zn²⁺) (1)

However, the Li∥NO₂ cell generates NO as the final reduzate, which is an additional air pollutant. Currently, there is no electrochemical method available to capture and utilize exhausted NO₂ for the production of value-added chemicals and simultaneous generation of electrical power. Therefore, the present invention introduces a high-energy rechargeable aqueous Zn∥NO₂ electrochemical cell, which offers a new approach to convert NO₂ from exhaust gas streams into value-added products while generating significant amounts of electrical energy.

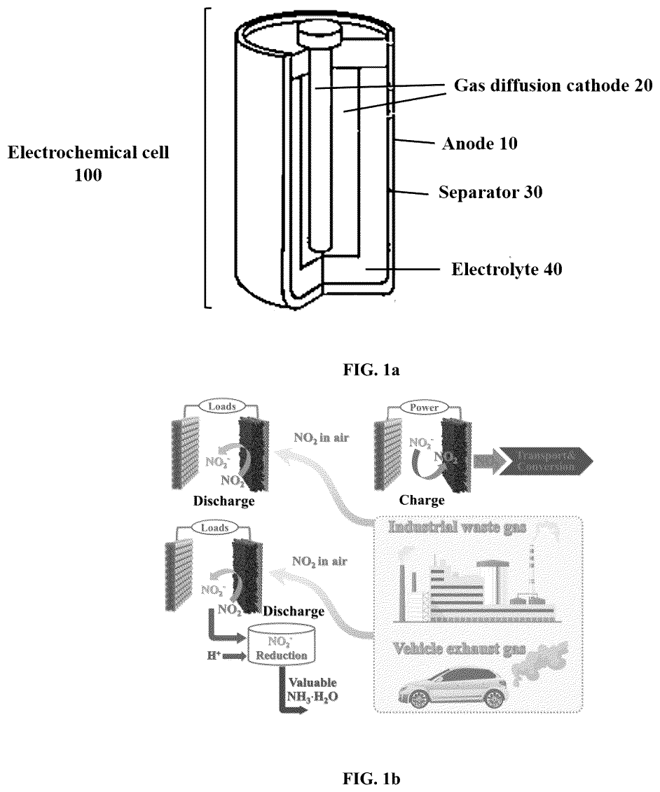

Referring to FIG. 1a, the high-energy rechargeable aqueous Zn∥NO₂ electrochemical cell (100) includes an anode (10), a gas diffusion cathode (20) formed by at least one nano NiO catalyst-deposited material and located under a gas source, a separator (30) placed between the gas diffusion cathode (20) and the anode (10), and an electrolyte (40) disposed in a space between the gas diffusion cathode (20) and the anode (10). The rechargeable aqueous Zn∥NO₂ cell delivers a high specific capacity of at least 800 mAh·g⁻¹ with an output voltage of 1.79 V at 0.2 mA·cm⁻², and when the current increased up to 20 mA·cm⁻², the rechargeable aqueous Zn∥NO₂ cell delivers a high capacity of at least 700 mAh·g⁻¹ with at least 90% capacity retention.

More specifically, the Zn∥NO₂ electrochemical capture system may be operated in either secondary (rechargeable) or primary (non-rechargeable) modes.

FIG. 1b shows the architectures of Zn∥NO₂ electrochemistry technology as a capture system, in which NO₂ is reduced to generate electrical energy during discharge process, and NO₂ is concentrated by recharging. In a secondary cell, the reduced NO₂ species react with oxidized metal ions to form metal nitrates and electricity during cell discharge. Ideally, during the recharge process, the cell undergoes a reverse reaction where electrical energy is consumed to release the captured NO₂ at the cathode and regenerate the metal anode. The implementation of such secondary electrochemical process would facilitate the separation and concentration of NO₂, based on the below electrochemical reaction:

NO₂⁻-e⁻→NO₂ (2)

Another configuration according to the present invention is a primary electrochemical cell, in which the metal anode is consumed to generate electrical energy and discharge products. These discharged products can be harvested from the electrode, electrolyte, and other cell components, and then converted into valuable chemicals (FIG. 1), based on the following electrochemical reaction:

NO₂⁻+5H++4e⁻→NH₃+2H₂O (3)

In one of the embodiments, a primary Zn∥NO₂ is used, in which the captured NO₂ is converted to valuable products NH₃—H₂O.

In one of the embodiments, the high energy density is calculated based on the mass of total loaded materials on both electrodes, electrolyte, and package.

In one of the embodiments, the nano-NiO catalyst exhibits an electrocatalytic performance of at least 350 mV for overpotential at 10 mA·cm⁻², and the nano-NiO catalyst exhibits a Tafel slope lower than 65 mV·dec⁻¹.

However, in addition to the nano-NiO catalyst, other catalysts can also be used in the present invention, such as commercial Pt/C, CuO, FeO, CoO and NiO catalysts, or any other material that achieves NO₂→NO₂⁻.

In one of the embodiments, the anode material may be metal foil or metal plate. The metal may be aluminum (Al), iron (Fe), nickel (Ni), Lead (Pb), or copper (Cu). Preferably, the anode may be Zn foil or Zn plate.

In one of the embodiments, the electrolyte may be ZnCl₂ solution, Zn(OTf)₂ solution, ZnSO₄ solution, or KOH solution, or a combination thereof.

In one of the embodiments, the separator may be polypropylene/polyethylene/polypropylene (PP/PE/PP) separator, poly(tetrafluoroethylene) (PTFE), poly(vinyl chloride) (PVC) and polyamide (PA), or any commercial separators.

In one of the embodiments, the at least one nano NiO catalyst-deposited material may be carbon fiber cloth (CFC), fluorocarbon-based polymer (e.g., Nafion™) or isopropanol.

In one of the embodiments, a device having the nano NiO catalyst exhibits a high open circuit voltage (OCV) of at least 1.8 V under NO₂ atmosphere, which is higher than that of the commercial NiO electrocatalyst (1.75V). For example, at least 1.83V, at least 1.85V, or at least 2.0V.

In one of the embodiments, the rechargeable aqueous Zn∥NO₂ cell has a peak power density of at least 80 mW·cm⁻². For example, at least 85 mW·cm⁻², at least 90 mW·cm⁻², at least 95 mW·cm⁻².

In one of the embodiments, the gas source is NO₂. The rechargeable aqueous Zn∥NO₂ cell works with at least 3 vol. % NO₂ gas diffusing. The gas diffusion cathode is based on the NO₂/NO₂⁻ redox reaction.

In one of the embodiments, the rechargeable aqueous Zn∥NO₂ cell is of Ah-scale. Preferably, the rechargeable aqueous Zn∥NO₂ cell is of 2.4 Ah-scale.

In one of the embodiments, the rechargeable aqueous Zn∥NO₂ cell delivers a high energy density of at least 500 Wh·kg⁻¹_{cell} and a high volumetric density of 1500 Wh·L⁻¹_{cell}. For example, the energy density can be at least 510 Wh·kg⁻¹_{cell}, at least 520 Wh·kg⁻¹_{cell}, at least 530 Wh·kg⁻¹_{cell}, at least 540 Wh·kg⁻¹_{cell}, at least 550 Wh·kg⁻¹_{cell}, at least 560 Wh·kg⁻¹_{cell}, at least 570 Wh·kg⁻¹_{cell}, at least 580 Wh·kg⁻¹_{cell}, at least 590 Wh·kg⁻¹_{cell}, or at least 600 Wh·kg⁻¹_{cell}. The volumetric density can be at least 1525 Wh·L⁻¹_{cell}, at least 1550 Wh·L⁻¹_{cell}, at least 1575 Wh·L⁻¹_{cell}, at least 1600 Wh·L⁻¹_{cell}.

Preferably, the energy density is 553.2 Wh·kg⁻¹_{cell}, and the volumetric density is 1589.6 Wh·L⁻¹_{cell}.

In one of the embodiments, the rechargeable aqueous Zn∥NO₂ cell demonstrates cycling stability over 100 h at a current density of 5 mA·cm⁻² with a charge or discharge time of 1 h, and the energy efficiency reaches at least 80%. For example, the cycling stability can more than 110 hr, more than 120 hr, more than 130 hr, more than 140 hr, more than 150 hr, etc. The energy efficiency can reach at least 85%, at least 90%, at least 95%.

Additionally, the present invention further provides a self-powered Haber-Bosch reactor for NH₃ production. The reactor includes a graphite bipolar plate, an ion exchange membrane, a TiO₂/CFC electrode, and at least two rechargeable aqueous Zn∥NO₂ cells connected in series to drive the subsequent electrocatalytic reduction for NH₃ synthesis.

In one embodiment, the produced NO₂⁻ by Zn∥NO₂ cell can be further converted to NH₃ by two Zn∥NO₂ cells powered conversion system with an electrochemical Haber-Bosch (eHB) reactor employed.

The following examples illustrate the present invention and are not intended to limit the same.

### EXAMPLE

### Example 1—Sample Preparation

### Preparation of Nano-NiO Particles

Ni(OH)₂ (1.0 g, 10.79 mmol) was added into a vial, then 2.0 ml of H₂O:isopropanol (2:1) was added to the above vial. The suspension was sonicated at room temperature for 4 h to make it a homogeneous mixture. Water and isopropanol were then removed using a rotary evaporator under vacuum condition. The resulting wet slurry was dried in an oven at 50° C. overnight. The solid powder was then heated to 300° C. in a furnace for 3 h to obtain the nano NiO particles.

### Preparation of NO₂ Gas

The pure NO₂ gas was prepared by reducing concentrated nitric acid with copper metal at room temperature. The rate of gas production was controlled by controlling the drop acceleration rate of concentrated nitric acid. The different concentration of NO₂ gas was prepared by mixing different volumes of pure NO₂ with air using a gas pump.

### Example 2

### Characterization of Materials

Crystallographic data was collected by a Bruker D2 Phaser X-ray diffractometer with Cu Kα irradiation (k=0.154 nm) operating at 30 kV and 10 mA, respectively. Surface morphology was investigated by scanning electronic microscopy (SEM, JEOL JSM-6335F), transmission electronic microscopy (TEM, Philips CM20), and high-resolution transmission electron microscope (HRTEM, JEOL 2100F). The chemical state and composition were analyzed using an ESCALAB 250 photoelectron spectroscopy (Thermo Fisher Scienctific) at 1.2×10⁻⁹ mbar using Al Kα X-ray beam (1486.6 eV). All XPS spectra were calibrated by shifting the detected adventitious carbon C is peak to 284.4 eV. For ex-situ studies, the cycled electrodes were washed with a copious amount of water and thoroughly dried in a vacuum at room temperature. The chemical coordinated information was obtained by X-ray absorption fine spectroscopy (XAFS) spectra conducted at the beamline 1W1B of Beijing Synchrotron Radiation Facility (BSRF) at Institute of High Energy Physics, Chinese Academy of Sciences. The storage rings of BSRF were conducted at 2.5 GeV with an average current of 250 mA. The data collection was conducted in transmission mode using ionization chamber when using Si (111) double-crystal monochromator. The data was processed and analyzed similar to previous procedures using ATHENA and ARTEMIS for X-ray absorption near edge structure (XANES) and the extended X-ray absorption fine structure (EXAFS) spectra, respectively.

For electrochemical test, an electrocatalyst/Ketjen black mixture slurry was prepared by dispersing 8 mg of electrocatalyst and 2 mg Ketjen black into 1 mL of mixture solution of 2-propanol, distilled water, and Nafion solution (5 wt %) (10:40:1). Then, the gas electrode was fabricated using a spraying above mixture slurry on carbon cloth and dried at room temperature for 24 h. The loading mass was 0.5 mg·cm⁻² for all catalysts. A polished Zn plate served as the anode and the electrolyte is 2 M ZnCl₂ aqueous solution for rechargeable Zn∥NO₂ batteries. The gas diffusion layer had an effective area of 1 cm² and allowed NO₂ gas to reach the catalyst sites. The charge/discharge polarization were determined utilizing an electrochemical workstation (CHI 760e, Chenhua). The galvanostatic test were performed using a Keithley 2450 source measurement unit at room temperature.

For ammonia synthesis, the fabrication of the dual-compartment cell and relevant electrocatalytic reduction was shown in detail as follows. A piece of TiO₂/carbon cloth (3 cm×2 cm) was combined with a piece of pre-activated Nafion membrane (NRE-211, 3.5 cm×2.5 cm) by a hot press process at 140° C. for 0.5 h. The combination was assembled with two pieces of silicone and custom-made graphite bipolar plates (4 cm×3 cm) with grooves to fabricate the dual-compartment cell. Next, 20 mL of pure water and NO₂⁻ solution (from Zn∥NO₂ cell) were recycled in the anode and cathode compartment with the help of two peristaltic pumps, then both reactions were driven by two Zn∥NO₂ cells connected in series.

### Characterization of Liquid Products

NO₂⁻, NO₃⁻, and NH₄⁺ productions were detected colorimetric detection methods coupled with UV-vis spectroscopy (PerkinElmer Lambda 2S spectrometer). Detailed detection methods for each kind of ions were shown as following:

(1) Colorimetric Detection of NO₂⁻

First, diluted electrolyte (5 mL) was mixed with solution containing HCl (0.10 mL, 2.0 M) and sulfanilamide (10 g·L⁻¹). After 10 min, a C₁₂H₁₄N₂·2HCl solution (100 μL, 10 mg·mL⁻¹) was added into the above solution with gentle shaking. The absorption of NO₂⁻ was measured at a wavelength range from 650 to 450 nm after 30 min. The absorbance value of NO₂⁻ was obtained at the wavelength of 540 nm. Similar to the aforementioned procedure, the standard calibration curve could be obtained by fitting the absorbance of the different known concentrations of NaNO₂ (0, 4, 8, 12, and 16 μM).

(2) Colorimetric Detection of NO₄⁺

The indophenol blue method was used to detect NH₄⁺. Electrolyte diluted with a H₂SO₄ solution (0.05 M) was used as the test sample. A solution (1.25 mL) consisting of NaOH (0.625 M), salicylic acid (0.36 M), and sodium citrate (0.17 M) was added into test sample (2 mL). A sodium nitroferricyanide solution (150 μL, 10 mg·mL⁻¹) and NaClO solution (75 μL, available chlorine 4.0 wt %) were further added. After placing the solution in ambient temperature for 2 h, absorption spectra were collected, and the absorbance value at the wavelength of 658 nm was obtained to characterize the NH₄⁺ concentration. For standard calibration curve, different NH₄⁺ solutions of known concentrations (0, 5, 10, 15, 20 μM) were obtained by dissolving (NH₄)₂SO₄ into H₂SO₄ (0.05 M). The obtained absorbance values were then linear fitted for calibration.

(3) Colorimetric Detection of NO₃⁻

The electrolyte was diluted with H₂SO₄ (0.05 M) before testing. Then, a HCl solution (0.10 mL, 1.0 M) was added into a test solution (5 mL). After 15 min, the absorption of NO₃⁻ was measured at a wavelength range from 300 to 200 nm. The characteristic absorbance of NO₃⁻ was calculated based on the absorbance value difference at 220 and 275 nm. The standard calibration curve was obtained by fitting different known concentrations of NaNO₃ (0, 5, 10, 15, and 20 μM).

### Computational Details

All spin-polarized density functional theory (DFT) calculations were performed by employing the projector-augmented wave method implemented in VASP code¹⁰⁻¹¹. Perdew-Burke-Ernzerhof flavor of generalized gradient approximation was applied for the exchange-correlation functional¹². The kinetic energy cutoff, energy and force convergence criteria were set as 400 eV, 10-5 eV, and 0.05 eV/A, respectively. The K-points mesh was set as 3×3×1 for Brillouin zone sampling. DFT-D3 method with Becke-Jonson damping was used to the van der Waals interaction correction¹³⁻¹⁴. DFT+U scheme was applied to correct the self-interaction error for 3d electrons, and U-J values were set as 5.3, 3.32, 6.2, and 7.29 eV for Fe, Co, Ni, and Cu, respectively¹⁵⁻¹⁶. A vacuum layer with the thickness of 15 Å was added to avoid the spurious interactions between adjacent cells. The charge density difference distribution (CDDD) Δρ of adsorbed *NO₂ was calculated as

Δρ=ρ(*NO₂)−ρ(*)−ρ(NO₂), where ρ(*NO₂),ρ(*),

and ρ(NO₂) denoted charge density distribution of adsorbed *NO₂, clean surface, and NO₂ only. The number of charge transfer was estimated by Bader charge analysis¹⁷. The Gibbs free energy change ΔG was calculated by

ΔG=ΔE+ΔZPE−TΔS,

where ΔE, ΔZPE, and ΔS denotes the changes in DFT-calculated total energy, zero-point energy, and entropic contributions, respectively. The temperature was set as 298K, and the entropy value for HNO₂ (g) was extracted from the NIST database (https://doi.org/10.18434/T4D303). Norskov's computational hydrogen electrode (CHE) model was used in the calculations. For ORR, a pH correction term ΔGpH=kT ln 10×pH was applied¹⁸.

### Example 3—Fabrication of Aqueous Zn∥NO₂ Electrochemical Cell

In this example, an aqueous Zn∥NO₂ electrochemical cell was developed by employing metallic Zn as the anode, electrocatalysts deposited on CFC as cathode, and aqueous solution of ZnCl₂ as the electrolyte.

### Example 4—Screening Catalysts and Analysis of Catalytic Activity

The screening of electrocatalytic activity for NO₂⁻↔*NO₂ conversion (‘*’ denotes the adsorbed state) on different metal oxide surfaces, including NiO, CoO, FeO and CuO, was scrutinized analyzed by density functional theory (DFT) calculations.

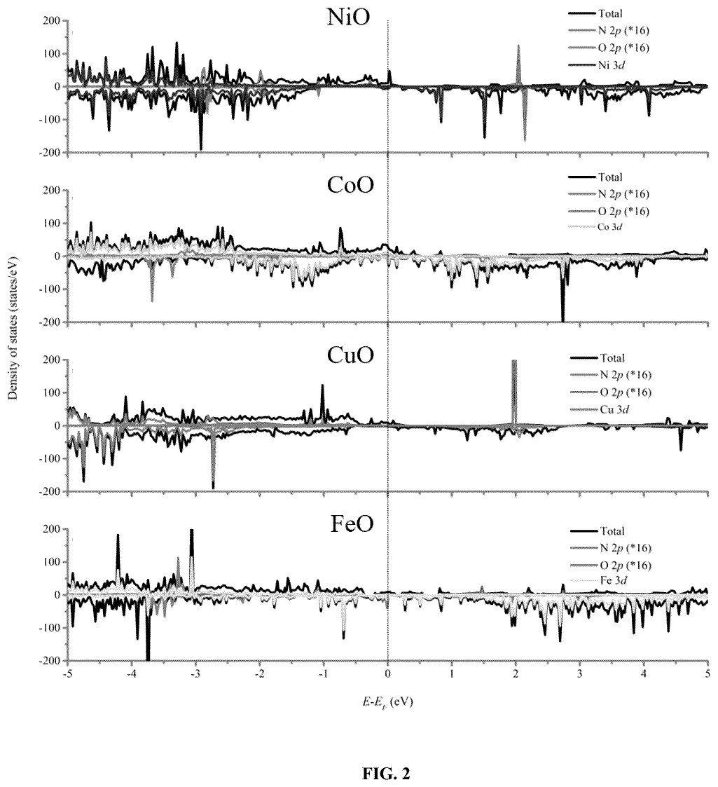

The DOS describes the number of energy states per unit volume or per unit energy interval that are available to particles in a given system. It provides information about the energy levels and their occupancy, which is essential for understanding various phenomena, such as electrical conductivity, thermal conductivity, and optical properties of materials. The DOS is often represented as a plot or a function that shows the energy levels on the x-axis and the density of states on the y-axis. Referring to FIG. 2, the hybridization between transition metal (Ni, Co, Cu, Fe) 3d orbitals and nitrogen/oxygen 2p orbitals at around 2 eV and from −4 to −2.5 eV could be observed, which contributed to the favorable adsorption of NO₂.

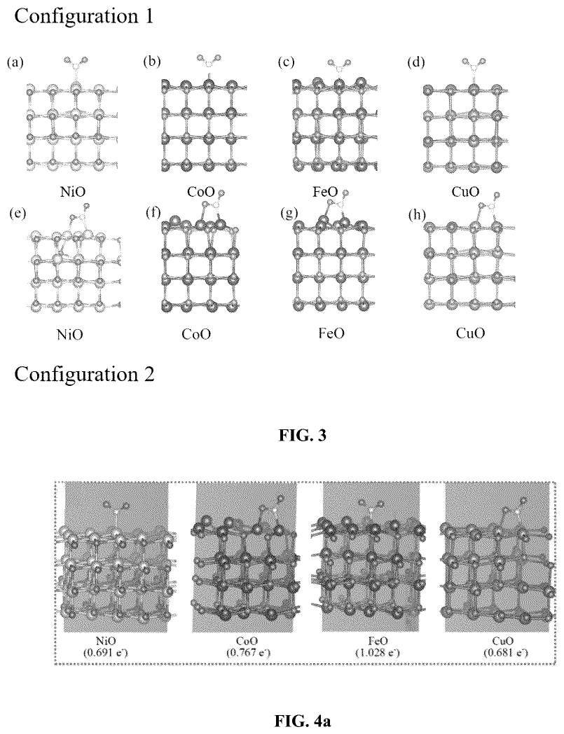

FIG. 3 shows structures of NO₂ adsorption configuration 1 and configuration 2 on NiO, CuO, FeO and CuO surfaces. The charge transfers from NiO, CoO, FeO and CuO surface to *NO. After comparing two different NO₂ adsorption configurations (FIG. 3), it could be found that on NiO and FeO, the preferred configuration for *NO₂ is configuration 1 and only N atom binds to metal site. On the other hand, on CoO and CuO, the preferred configuration for *NO₂ is configuration 2, where both N and O atoms bind to adjacent sites.

Charge density difference distribution (CDDD) refers to the analysis of the spatial variation in the distribution of electron density between two or more different states or configurations of a system. It provides insights into the redistribution of electronic charge, which can be associated with changes in chemical bonding, electronic structure, or reactivity. The analysis of charge density difference distribution provides a deeper understanding of the electronic structure and chemical properties of systems.

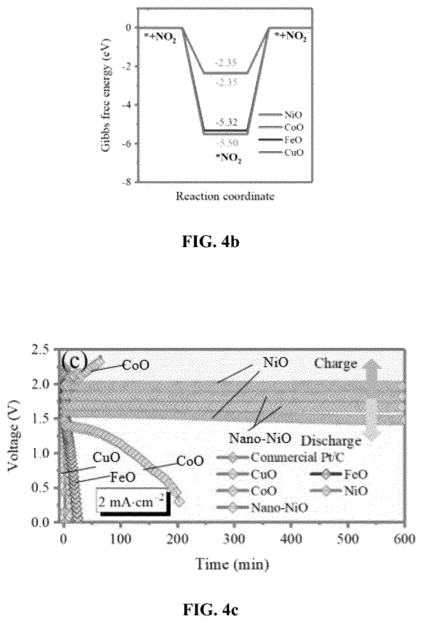

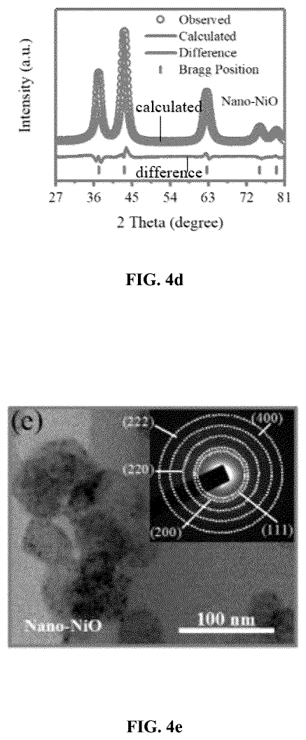

FIG. 4 shows (FIG. 4a) 2D contour plot (0.005 e Bohr⁻¹) of charge density difference distribution (CDDD) of adsorbed *NO₂ on NiO, CoO, FeO and CuO with the iso-surface value of 0.005 e Bohr⁻³. Meanwhile, the number of charge transfer from metal oxide surface to *NO₂ is also denoted. (FIG. 4b) Gibbs free energy diagrams for NO₂⁻↔NO₂ conversion on NiO, CoO, FeO, and CuO surface. The Gibbs free energy of CoO is covered by that of NiO. (FIG. 4c) The galvanostatic charge/discharge curves of the Zn/NO₂ electrochemical cell at a current density of 2 mA·cm⁻² with commercial Pt/C, CuO, FeO, CoO, NiO and nano-NiO electrocatalysts. (FIG. 4d) XRD pattern of nano-NiO and the corresponding results of the Rietveld refinement. Refined parameters are space group: R-3m; a=2.97 Å; c=7.27 Å. (FIG. 4e) TEM image of nano-NiO. The inset is the corresponding SEAD pattern.

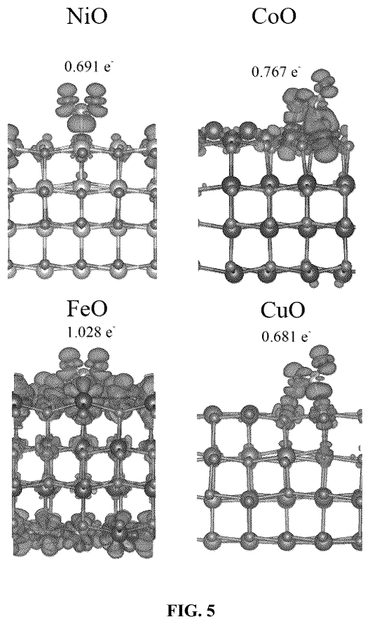

FIG. 5 shows the charge density difference distribution (CDDD) of adsorbed *NO₂ on NiO, CoO, FeO, and CuO with the isosurface value of 0.005 e Bohr⁻³. The charge transfers from NiO, CoO, FeO, and CuO surface to *NO₂.

The results in FIG. 4a and FIG. 5 showed a clear two-way charge transfer between metal oxides and NO₂, with charge accumulated in the top/bottom regions of O atoms and around metal-N/metal-O bonds, while charge depletion existed around the O atoms. Bader charge analysis indicated that NiO exhibited a relatively smaller charge transfer value from the surface to *NO₂ (0.691 e⁻), in line with the charge density difference distribution results. Therefore, NO₂ was weakly trapped on the surface, which facilitated the desorption and two-way NO₂⁻↔*NO₂ conversion.

In addition, Gibbs free energy diagrams presented in FIG. 4b indicated that the conversion from *+NO₂⁻ to *NO₂ was energetically favorable, therefore the overall reaction thermodynamics were limited by the NO₂ desorption. The results showed that both NiO and CoO exhibited a desorption Gibbs free energy change of 2.35 eV, which was considerably smaller than that for FeO (5.32 eV) and CuO (5.50 eV). These results indicated that NiO had the best performance in catalyzing the NO₂⁻↔*NO₂ conversion.

NO₂RR stands for “NO₂ Reduction Reaction.” It is an abbreviation commonly used in the fields of chemistry and electrochemistry, referring to the chemical reaction that converts nitrogen dioxide (NO₂) into other compounds or products. To deliver a highly efficient conversion, electrocatalyst with high activity and selectivity for NO₂RR are a prerequisite. In general, the NO₂RR polarization curve exhibits similar features to those of the hydrogen evolution reaction (HER), including an onset potential and overpotential. In one embodiment, the electrocatalytic activities of NO₂RR were examined using three-electrodes configuration, in which the catalysts-deposition carbon fiber cloth (CFC) serves as the working electrode, Pt foil as counter electrode, and Ag/AgCl as the reference electrode. Excess NO₂ was blown through a gas pump towards the CFC electrode.

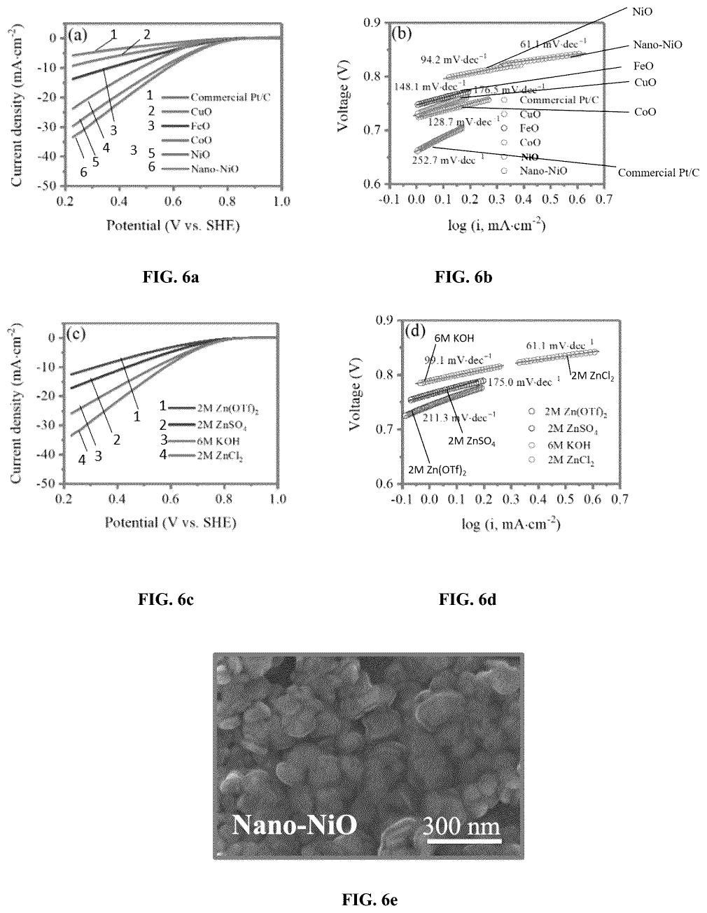

FIG. 6 depicts the (FIG. 6a) NO₂ reduction reaction polarization curves of the commercial Pt/C, CuO, FeO, CoO, NiO and nano-NiO electrodes at a scan rate of 5 mV·s⁻¹ in 2M ZnCl₂ aqueous solution and (FIG. 6b) corresponding Tafel plots of these catalysts. (FIG. 6c) NO₂ reduction reaction polarization curves of the nano-NiO electrodes at 5 mV·s⁻¹ in 2M Zn(OTf)₂, 2M ZnSO₄, 6M KOH and 2M ZnCl₂ aqueous solutions and (FIG. 6d) corresponding Tafel plots. (FIG. 6e) SEM images of nano-NiO.

Referring to FIG. 6a, the electrocatalytic performance of nano-NiO (420 mV for overpotential at 10 mA·cm⁻²) remarkably outperforms commercial Pt/C, CuO, FeO, CoO and NiO catalysts in 2M ZnCl₂ aqueous solution. Meanwhile, the nano-NiO catalyst exhibited lowest Tafel slope (61.1 mV·dec⁻¹) (FIG. 6b), suggesting the superiority of nano-NiO for NO₂RR.

Additionally, the NO₂RR behaviors of nano-NiO were examine in different electrolytes, including 2M Zn(OTf)₂, ZnSO₄, 6M KOH and 2M ZnCl₂ aqueous solutions. As shown in FIGS. 6c-6d, it exhibited both lowest overpotential and Tafel slope in 2M ZnCl₂ aqueous solutions, demonstrating the suitability of ZnCl₂ aqueous electrolyte for NO₂RR.

In one embodiment, the Zn∥NO₂ electrochemical cells were fabricated according to Example 3. As shown in FIG. 4c, when the batteries based on CuO, FeO, and commercial Pt/C electrocatalysts were charged or discharged, they exhibited a very large overpotential or experience a quick voltage drop to zero. This observation indicated a very sluggish electrocatalytic kinetic of Zn∥NO₂ electrochemical cells using commercial CuO, FeO and Pt/C as catalysts. Although the CoO electrocatalyst enabled the Zn∥NO₂ electrochemical cells to operate, the overpotential gradually increased during the charge/discharge processes. Encouragingly, NiO was particularly effective for catalyzing both the reductions of NO₂ and the oxidation of NO₂⁻.

Nevertheless, the energy efficiency of the Zn∥NO₂ cell was only 76.3%, and output voltage gradually decreased from 1.55 to 1.46 V after 600 min, indicating a gradually reduced electrocatalytic activity of NiO. Therefore, employing the nano-NiO electrocatalyst, the Zn∥NO₂ electrochemical cells could steadily and continuously generate electric power while the NO₂⁻ was efficiently oxidized.

The energy efficiency that was calculated by dividing the discharge voltage by the charging voltage, reached 92.6% when using the NiO nanoparticles (nano-NiO) electrocatalyst, which is much higher than that of the well-studied Zn-air batteries (<60%)¹⁹⁻²³. The improved electrocatalytic activity was attributed to sufficient active sites and rapid transport of electrons and ions with nanostructuration of NiO electrocatalyst.

### Example 5—Structure of Nano-NiO

To further enhance the catalytic efficiency of NiO, nano-NiO was fabricated via ultrasonic crushing method. The morphology and structure of the material were investigated using X-ray diffraction pattern (XRD), scanning electron microscopy (SEM) and transmission electron microscopy (TEM). The fabricated nano-NiO exhibited well-resolved but broader diffraction peaks with high intensity, indicating the presence of small crystallite sizes. The crystal structure was successfully refined with the space group of R-3m (FIG. 4d), which was similar to that of NiO.

The representative SEM image exhibited a uniformly well-defined bean pod-shaped structure with a diameter of approximately 100 nm (FIG. 6e). The TEM image depicted a dense bean pod-like structure, and the corresponding selected area electron diffraction (SAED) confirmed further its polycrystalline characteristics (FIG. 4e).

### Example 6—Electrochemical Performances of Zn∥NO₂ Electrochemical Cell

Electrochemical performance of the Zn∥NO₂ cells utilizing nano-NiO was investigated. The linear sweep voltammetry (LSV), open circuit voltage (OCV) and galvanostatic charge/discharge curves were conducted following the protocols well developed by Zn-air battery community.

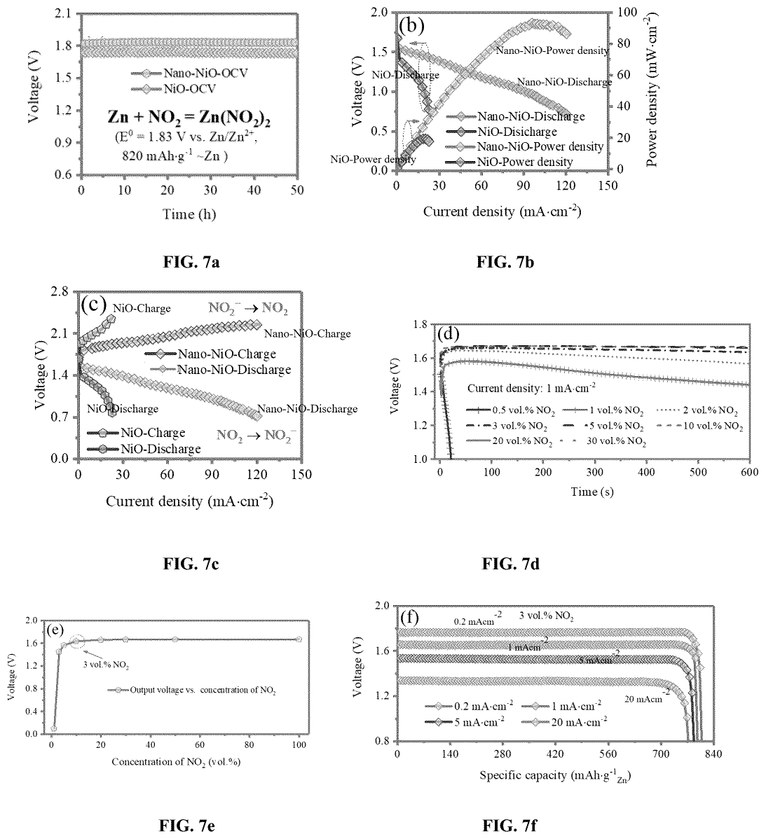

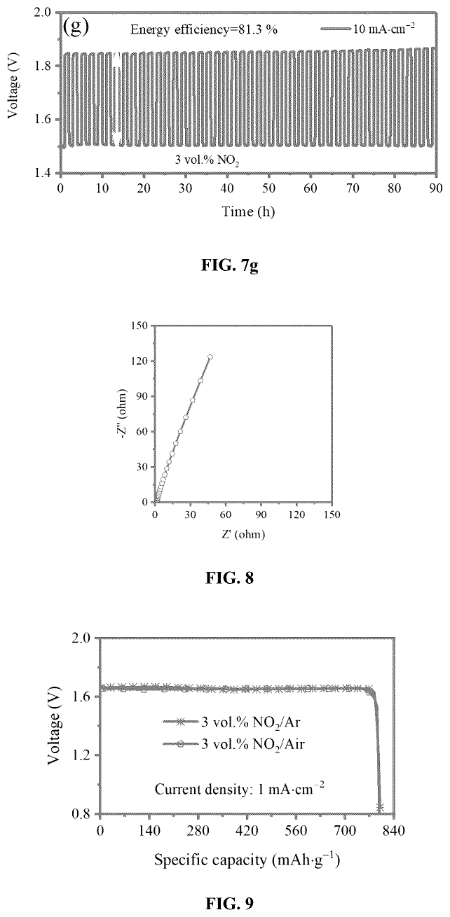

FIG. 7 depicts the Zn∥NO₂ electrochemical cell with NiO and nano-NiO catalysts: (FIG. 7a) Open circuit voltage over 50 h. (FIG. 7b) The discharged polarization profile and corresponding power densities curves at different densities. (FIG. 7c) Charge-discharge polarization profiles at different current densities. (FIG. 7d) Full discharged profiles recorded at different current densities of 0.2, 1, 5, 10 mA·cm⁻². (FIG. 7e) Cycling performance testing at 2 mA·cm⁻² using nano-NiO catalyst.

As shown in FIG. 7a, the device equipped with the nano-NiO electrocatalyst exhibited a high open-circuit voltage (OCV) of 1.83 V under a NO₂ atmosphere, which was close to the theoretical value of 1.85 V. This OCV was higher compared to the device using the commercial NiO electrocatalyst (1.75 V). As shown in FIG. 7b, the peak power densities of the Zn∥NO₂ electrochemical cells employing the NiO and nano-NiO reached 20.1 and 90.5 mW·cm⁻², respectively, validating the superior NO₂RR kinetics of nano-NiO. The symmetric charge/discharge curves in FIG. 7c indicated the bifunctional electrocatalysis of nano-NiO for NO₂RR and NO₂⁻ oxidation, surpassing the counterpart values of the NiO-based cells.

For the imitation of the practical application of the design of the present invention, the Zn∥NO₂ electrochemical cells employing different concentrations of NO₂ gas were studied. It was noted that a mixture of NO₂/air was used to simulate the contaminated gas by NO₂. As shown in FIGS. 7d-7e, for an NO₂ gas content was below 3 vol. %, the NO₂ gas was depleted during the discharged process. However, the Zn∥NO₂ electrochemical cells were able to steadily and continuously work when exposed to >3 vol. % NO₂ gas diffusion. Therefore, all subsequent experiments were conducted under the condition of 3 vol. % NO₂ gas.

Referring to FIG. 7f, the discharge curves of Zn∥NO₂ electrochemical cells at different discharge current densities were shown. The battery delivered a high specific capacity of 820 mAh·g⁻¹ with an output voltage of 1.79 V at 0.2 mA·cm⁻². When the current increased up to 20 mA·cm⁻², the battery could deliver a high capacity of 753 mAh·g⁻¹ with 91.8% capacity retention, manifesting an excellent rate capability. The excellent rate capability originates from fast NO₂RR kinetics and high ionic conductivity of aqueous electrolyte (47.65 mS·cm⁻¹) (FIG. 8).

In order to exclude the participation of air, the present invention further investigated the discharge voltage profile of Zn∥NO₂ cell at 1 mA·cm² with 3 vol. % NO₂/Ar diffused (FIG. 9). It was observed that their electrochemical behavior was nearly identical, suggesting that only nitrogen dioxide is involved in the electrochemical reaction.

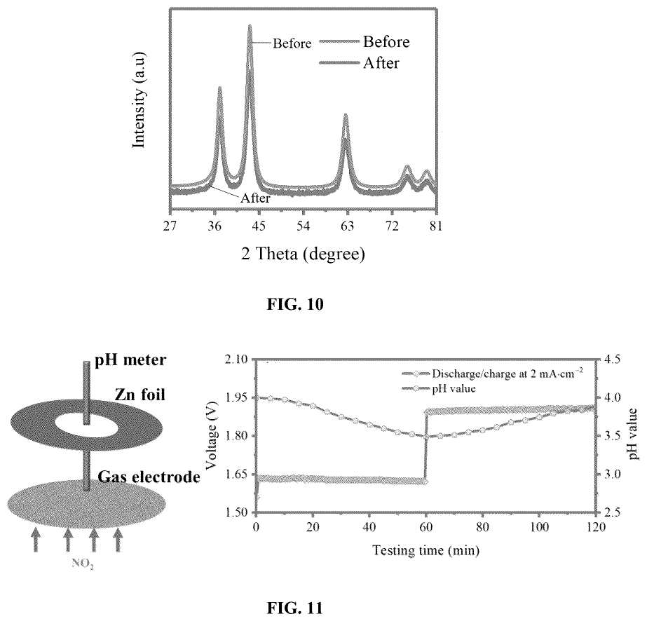

Long-term galvanostatic voltage profiles were recorded at an absolute current density of 10 mA·cm⁻² with a time span of 1 h for each charging and discharging step. In FIG. 7g, there is almost no polarization increased over 90 h and the phase composition of nano-NiO remains unchanged (FIG. 10), validating the stable nano-NiO electrocatalyst in the aqueous system and the high reversibility of the gas diffusion cathode based on the NO₂/NO₂⁻ redox reaction.

Furthermore, the changes of pH value are investigated by a home-made operando pH detection configuration (FIG. 11, left side). The pH value near the gas electrode gradually decreases from 3.96 to 3.49 during discharge process and is followed by a progressive increase to 3.89 at charged state (FIG. 11, right side), demonstrating a reversible pH change during the discharge/charge process and thus promoting the cyclic stability.

### Example 7—a 553.2 Wh·Kg⁻¹_{Cell}, 2.4 Ah-Scale Pouch-Type Zn∥NO₂ Cells

FIG. 12 depicts schematic illustration of rechargeable aqueous Zn∥NO₂ pouch cell with cathode-anode-cathode stack structure (FIG. 12a). A optical photograph of rechargeable aqueous Zn∥NO₂ pouch cell. (FIG. 12b) The delivered cell capacities of NO₂∥Zn∥NO₂ cells at different rates of 0.2 and 5 mA·cm⁻². (FIG. 12c) Ragone plots for projected cell-level specific (Wh·kg⁻¹_{(cell)}) and volumetric (Wh·L⁻¹) energy densities with representative commercial and reported batteries. (FIG. 12d) Galvanostatic cyclic charge/discharge performance of NO₂∥Zn∥NO₂ cell at a current density of 5 mA·cm⁻².

The Ah-scale Zn∥NO₂ cells within a more practical system assembled with a metallic Zn anode was fabricated using a symmetric configuration, wherein cathodes and electrolytes were positioned on both sides of a metallic Zn anode, as illustrated in FIGS. 12a.

The full-cell system could provide an output energy density of 553.2 Wh·kg⁻¹_{cell} during discharging (calculated based on the mass of total loaded materials on both electrodes, electrolyte, and package, illustrated in the pie chart in FIG. 13). The cell-level discharge capacity of 333.3 mAh·g⁻¹_{cell} at the current density of 0.2 mA·cm⁻² was recorded with a nominal cell voltage of 1.78 V using ˜2.4 Ah full cells (FIG. 12b). No obvious potential drop was observed in the galvanostatic discharging at different current densities (0.2 and 5 mA·cm⁻²) until the Zn plate was exhausted or broken, indicating good stability in the NO₂RR test.

Under realistic conditions, considering all active and inactive components, the Ah-scale Zn∥NO₂ cell achieved groundbreaking cell-level specific and volumetric energy densities of 553.2 Wh·kg⁻¹_{cell} and 1589.6 Wh·L⁻¹, respectively, based on all active and non-active materials. These values represent the highest cell energy densities ever reported among commercial Li-ion batteries, Zn-ion batteries and other advanced batteries²⁴⁻²⁹ (FIG. 12c). Note that the Ah-scale Zn∥NO₂ cells demonstrated cycling stability over 100 h at a current density of 5 mA·cm⁻² (charge/discharge time of 1 h), and the energy efficiency reaches 80.5%, which is better than all reported Zn-air batteries^{29-31, 33, 40, 41} (FIG. 12d).

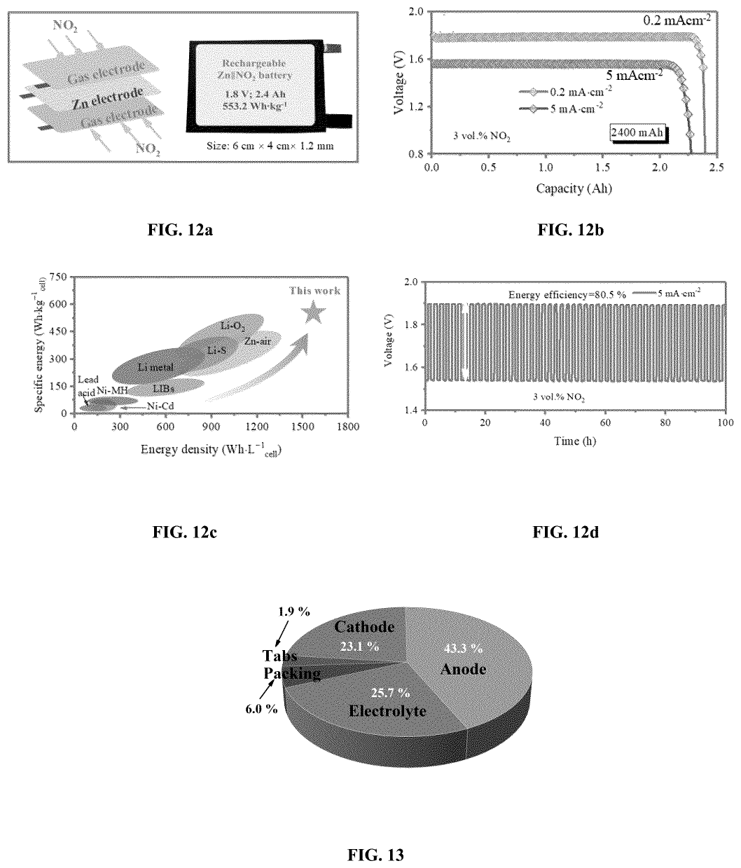

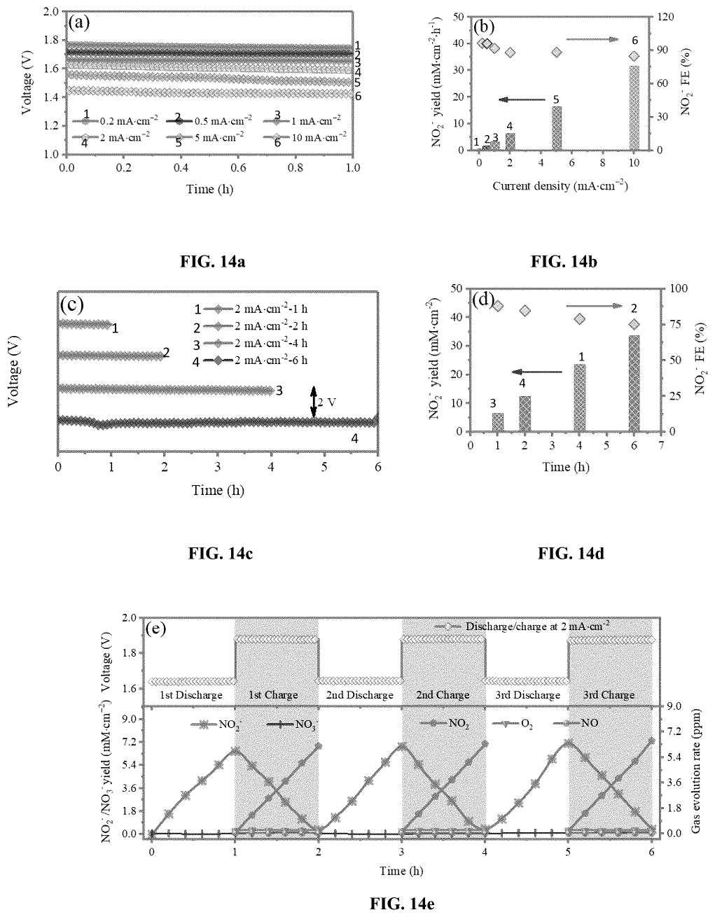

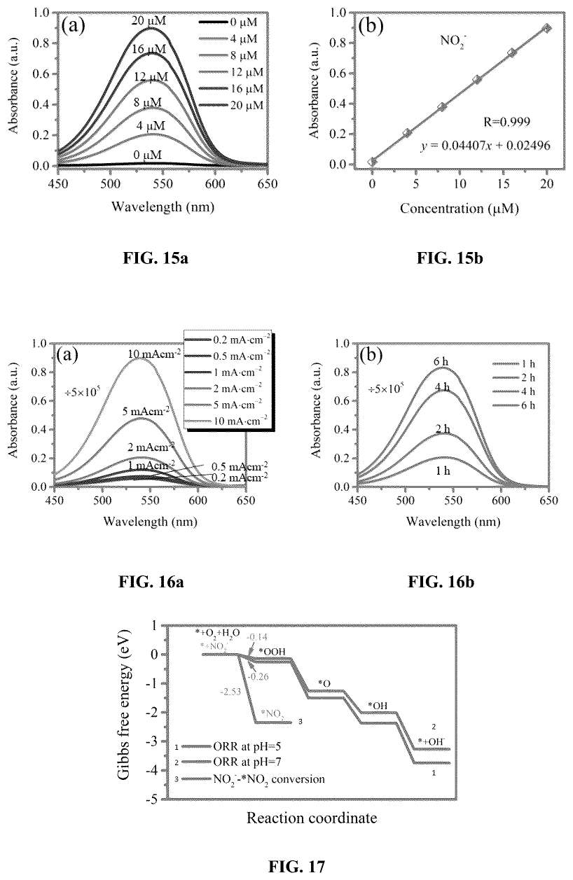

Another application of the Zn∥NO₂ cells is the production of value-added NO₂⁻, which can be further converted to NH₃. FIG. 14 shows (FIG. 14a) the galvanostatic discharge profile of a Zn∥NO₂ electrochemical cell at different current density of 0.2, 0.5, 1, 2, 5, 10 mA·cm⁻². The length of the black arrows represents 2 V. (FIG. 14b) Corresponding NO₂ species yield rates and faradaic efficiencies (FE). (FIG. 14c) The galvanostatic discharged profile of a Zn∥NO₂ electrochemical cell over different discharging time of 1, 2, 4, 6 h at 2 mA·cm⁻² and (FIG. 14d) corresponding NO₂⁻ species yield rates and FE. (FIG. 14e) Discharge-charge curves of first, second and third cycles recorded at 2 mA·cm⁻² over 2 h for one cycle. (FIG. 14e, bottom) Discharged/charged times dependence of the NO₂⁻, NO₃⁻, NO₂, NO, O₂ yield during cycling. Galvanostatic measurements were conducted to electrochemically produce NO₂⁻ at different current density for 1 h (FIG. 14a). The quantity of produced NO₂⁻ was indirectly determined by chromogenic reaction method coupled with UV-vis absorption, and the standard calibration curve was shown in FIGS. 15a-15b.

FIG. 16 depicts the UV-vis absorption spectra to determine the yield of NO₂⁻ by aqueous Zn∥NO₂ electrochemical cell (FIG. 16a) at different current density of 0.2, 0.5, 1, 2, 5, 10 mA·cm⁻², and (FIG. 16b) over different discharging time of 1, 2, 4, 6 h at 2 mA·cm². The UV-vis spectra of produced NO₂⁻ with different discharge current were given in FIG. 16a, and the corresponding calculated yield of NO₂⁻ was displayed in FIG. 14b. The yield of NO₂⁻ reached 3.42 mM·cm⁻²·h⁻¹ and the maximum Faraday efficiency (FE) was up to 96.4%. The yield of NO₂⁻ showed an almost linear increase with respect to the discharging current. Similarly, extending the time for NO₂⁻ evolution at a current density of 2 mA·cm⁻², the yield of NO₂⁻ also showed a linear increase (FIGS. 14c-14d, FIG. 16b). The above results indicate that the Zn∥NO₂ cells can sustain efficient and continuous production of NO₂—. The slight reduction of FE can be ascribed to the buildup of NO₂⁻ formed on the surface of the cathode, which reduces the number of catalytic active sites for absorbing NO₂⁻. This deficiency can be solved by optimizing experimental device design, such as adopting a flow cell.

Characterizations were performed to assess the reversibility of the NO₂/NO₂⁻ interconversion in a closed environment without oxygen/air, which was assumed for the rechargeable Zn∥NO₂ battery system. More accurate quantitative information on both the charge/discharge components and gas evolution was investigated to further confirm the reaction mechanism and pathway in the Zn∥(3 vol. % NO₂ in air) system. As shown in FIG. 14e during repeated cycling, the alternated increasing/decreasing and reversible variation trends of NO₂ and NO₂⁻ clearly indicated the reversible interconversion of NO₂↔NO₂⁻. Besides, NO₃⁻, NO and O₂ signals could not be observed, which suggested that there were no NO₃⁻/NO/O₂ redox processes during the subsequent cycles. The Gibbs free energy change for NO₂⁻↔*NO₂ conversion and oxygen reduction reaction (ORR) at pH=5 and 7 on NiO were also compared. As depicted in FIG. 17, the NO₂⁻↔*NO₂ conversion was more favorable than the ORR at both pH values. Both experimental and theoretical results collectively validate that, despite the diffusion of the mixed NO₂/air gas to the cathode of the Zn∥NO₂ electrochemical cell, no O₂/air is involved in the redox reactions during the charge and discharge processes.

### Example 8—Structure Evolution of Nano-NiO Deposited Cathode During the NO₂↔NO₂⁻ Redox Process

To unravel the structure evolution of the nano-NiO deposited cathode during the charge/discharge process, the ex-situ X-ray diffraction (XRD), X-ray photoelectron spectroscopy (XPS) and X-ray absorption near-edge spectroscopy (XANES) were performed.

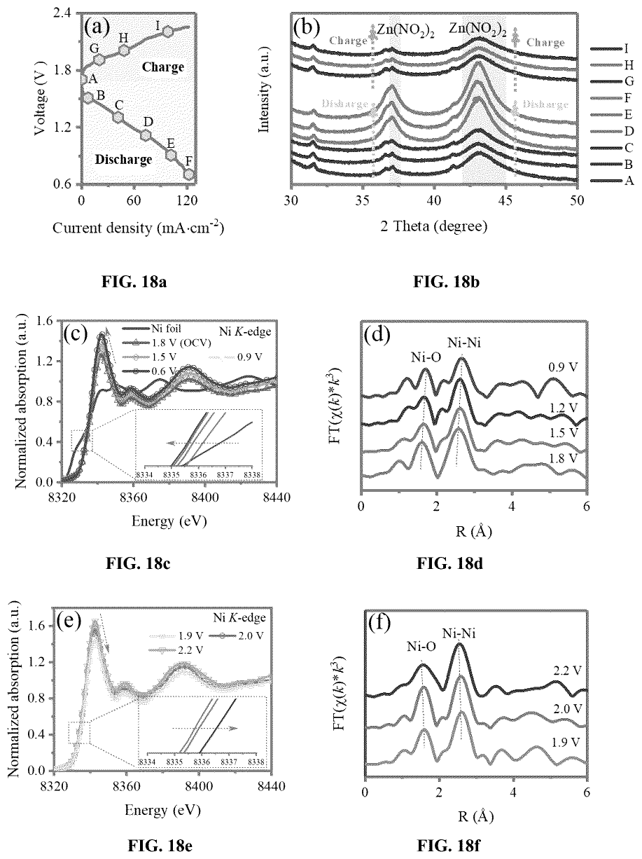

As shown in FIGS. 18a-18b, the discharging process corresponded to Zn⁰ losing electrons to form Zn²⁺ ions, and the Zn²⁺ first neutralized the absorbed NO₂⁻ on the surface of cathode to form Zn(NO₂)₂. Then, Zn(NO₂)₂ was deposited on the surfaces of the nano-NiO-based gas diffusion electrode. During the charging process, deposited Zn(NO₂)₂ in the positive electrode was decomposed, which was confirmed by the absence of Zn(NO₂)₂ in X-ray diffraction (XRD).

Then, the chemistries of nano-NiO electrocatalysts were studied by ex-situ XANES and XPS. Changes in the local electronic and atomic structures of the Ni sites of NiO in the charge/discharge electrocatalytic cycle were monitored by X-ray absorption spectroscopy, including X-ray absorption near edge structure (XANES) and extended X-ray absorption fine structure (EXAFS) analysis. FIGS. 18c-18f summarized the Ni K-edge X-ray absorption spectra during electrochemical cycling, including the discharging process from 1.8 to 0.6 V and charging processes from 1.8 to 2.2 V, respectively.

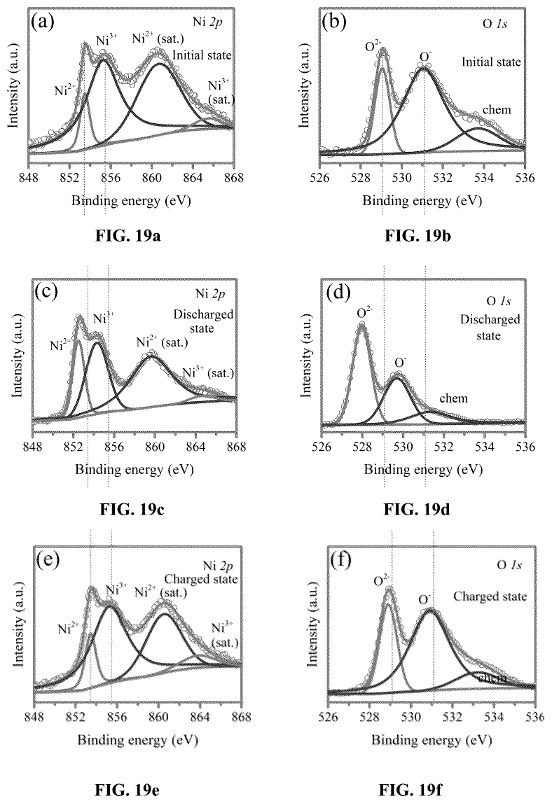

With discharging process (1.8-0.6 V), H₂O was disassociated to H_{ad} and OH_{ad} by breaking H—OH bond and the absorbed H_{ad} would combine with NO_{2ad} to form HNO₂. The Ni K-edge XANES peaks gradually shifted to a lower energy compared with the sample at open-circuit voltage of 1.8 V, demonstrating a gradually decreased average valence state in NiO³⁰⁻³¹ (FIG. 18c). The results were in line with the XPS results that the Ni 2p_{3/2} peaks of NiO after discharging reaction shifts to lower energy, compared with that of pristine NiO (FIGS. 19a-19f). FIG. 19 depicts high-resolution Ni 2p and O 1s spectra of nano-NiO at (19a, 19b) initial, (19c, 19d) discharged and (19e, 19f) charged states. Ni 2p spectra at initial, discharged and charged states. O 1s spectra at initial, discharged and charged states. Correspondingly, the Fourier transform of the extended X-ray absorption fine structure (FT-EXAFS) of the interatomic Ni—O distance was enlarged from 1.59 Å to 1.69 Å at an OCV of 0.9 V (FIG. 18d), implying the reduction of Ni ion with the discharging process. While during charging process, the H—NO₂⁻ was broken and dissociated to H_{ad} and NO_{2ad} on NiO surface. The disassociated H_{ad} will occupy the exposed 0 site of NiO. The Ni K-edge XANES peaks reversibly shift back to higher energy with the charging process (1.9-2.2 V), indicating an increase in Ni oxidation state³²⁻³³ (FIG. 18e). Accordingly, the interatomic Ni—O distance was reduced from 1.69 Å at 1.9 to 1.59 Å at 2.2 V (FIG. 7f). The above results support the reversible transitions of the Ni K-edge, manifesting symmetric Ni²⁺/^{x+} (1<x<2) redox reactions.

### Example 9—Self-Powered Haber-Bosch Reactor for NH₃ Production

Electrochemical nitrate reduction from NO₂⁻ into NH₃ is promising for the future landscape of NH₃ electrosynthesis based on the following six-electron reaction:

NO₂⁻+7H⁺+6e⁻→NH₃+2H₂O (4)

On the other hand, water electrolysis is a modular alternative H⁺ source by using a commercially available water splitting setup, based on the following four-electron reaction:

2H₂O-4e⁻→O₂+4H⁺ (5)

Based on the above reactions of nitrate reduction and water oxidation, the present invention couples the two reactions in an electrochemical Haber-Bosch (eHB) reactor. This reactor produces NH₃ from NO₂⁻ and H⁺ under ambient conditions, involving only NO₂, H₂O, and renewable electrons in an overall reaction.

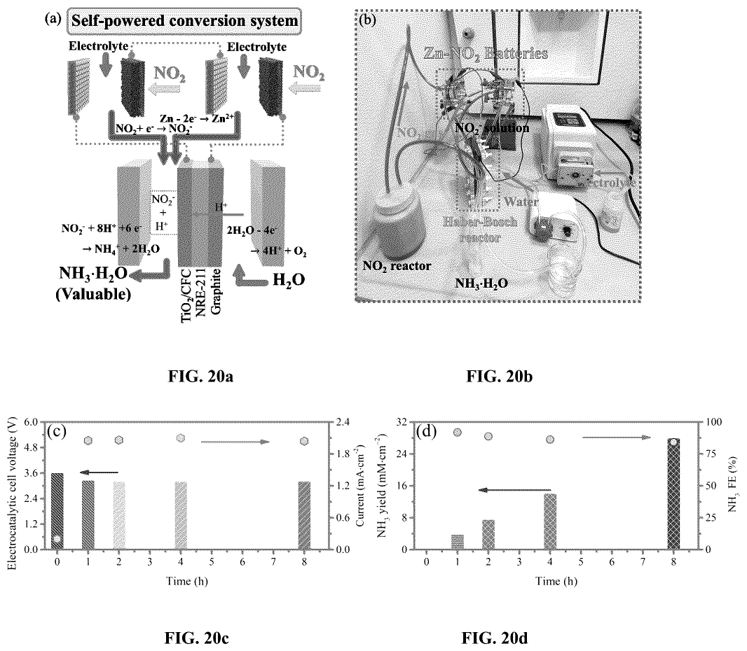

For improving electrocatalytic kinetics, an effective, cheap and low-toxicity catalyst of commercial nano-TiO₂ (P25) was employed in the electrocatalytic system for NH₃ synthesis. Schematic diagram and optical photo were depicted in FIGS. 20a-20b, respectively.

The eHB system with a dual-compartment electrocatalytic cell consists of a graphite bipolar plate, Nafion membrane (NRE-211), and a TiO₂/CFC electrode. The eHB reactor could be powered by two Zn∥NO₂ cells connected in series to drive the subsequent electrocatalytic reduction for NH₃ synthesis. Noted that the generated NO₂⁻ from Zn∥NO₂ cells could directly flow into eHB reactor for further NH₃ production. Therefore, as long as keeping providing the electrolyte and NO₂ gas, the self-powered eHB could keep producing NH₃.

FIG. 20c showed the voltage and output current of electrocatalytic cell. With the duration extended, the voltage maintains 3.0 V unchanged and the output current was about 2.1 mA·cm⁻² over 8 h, demonstrating continuous and stable electrocatalytic reactions for NH₃ synthesis.

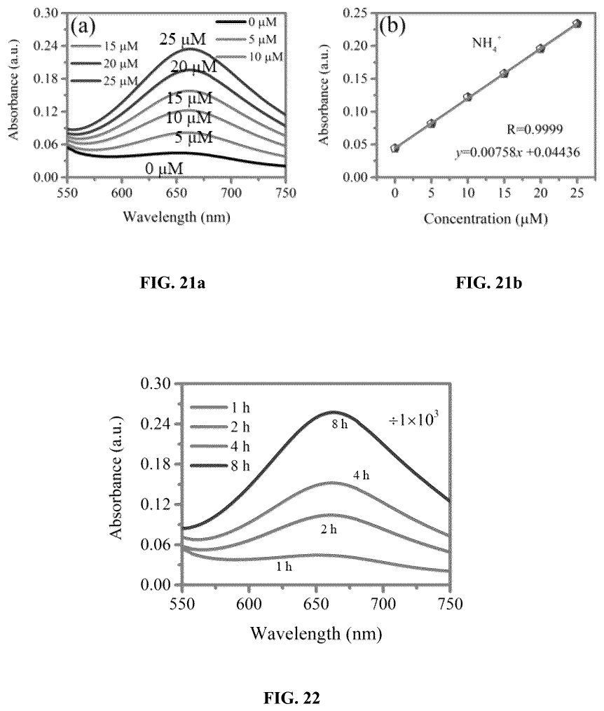

FIGS. 21a-21b depict the UV-Vis absorption spectra and concentration-absorbance standard calibration curve using the indophenol blue method for different concentrations of NH₄⁺ ions. FIG. 22 depicts the UV-vis absorption spectra to determine the yield of NH₄⁺ by self-power conversion system over different discharging time of 1, 2, 4, 8 h. After 1 h of reaction, NH₃ was successfully synthesized by the self-powered system. The determination results calculated according to UV-vis absorption (FIGS. 21-22), were shown in FIG. 20d. By measuring the solution volume involved in the cathode reaction, the self-powered NH₃ yield per hour achieved 4 mM·h⁻¹. Therefore, it is feasible to reutilize the residual kinetic energy of the exhaust gas to drive the valuable NH₃ synthesis.

In summary, the present invention relates to an electrochemical cell of aqueous Zn∥NO₂ battery system, which can efficiently capture and convert NO₂ to NO₂—, and to final value-added NH₃, together with simultaneously produce a significant amount of electric power. Preferably, the aqueous rechargeable Zn∥NO₂ system has a 1.8 V discharge voltage based on reversible NO₂⁻↔NO₂ conversion, and the energy efficiency reaches 81.3% with 3 vol. % NO₂/air diffused at 10 mA·cm² (FIG. 7g). The assembled pouch-type 2.4 Ah-scale battery can deliver a high energy density of 553.2 Wh·kg⁻¹_{cell} and a high volumetric density of 1589.6 Wh·L⁻¹_{cell}. to the system is capable of utilizing the NO₂ exhaust gas for ammonia synthesis, which is energy-saving and eco-friendly. The yield of the NO₂⁻ ions reaches 3.42 mM·cm⁻²·h⁻¹ and the Faradaic efficiency is about 96.4%.

The produced NO₂⁻ can be further converted to NH₃ by a self-powered conversion system that consists of two Zn∥NO₂ cell connected in series and an electrochemical Haber-Bosch reactor. This work opens a new avenue for NO₂ capture/conversion via reversible aqueous metal∥NO₂ systems and eco-friendly conversion/storage devices.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

### REFERENCES: THE DISCLOSURES OF THE FOLLOWING REFERENCES ARE INCORPORATED BY REFERENCE

1. Sadat, W. I. A.; Archer, L. A., Sci. Adv. 2016, 2 (7), e1600968.
2. Park, H.; Lim, H. D.; Lim, H. K.; Seong, W. M.; Moon, S.; Ko, Y.; Lee, B.; Bae, Y.; Kim, H.; Kang, K., Nat. Commun. 2017, 8 (1), 14989.
3. Li, J.; Wang, L.; Zhao, Y.; Li, S.; Fu, X.; Wang, B.; Peng, H., Adv. Funct. Mater. 2020, 30 (27), 2001619.
4. Xie, J.; Wang, X.; Lv, J.; Huang, Y.; Wu, M.; Wang, Y.; Yao, J., Angew. Chem. Int. Ed. 2018, 57 (52), 16996.
5. Wang, X.; Xie, J.; Ghausi, M. A.; Lv, J.; Huang, Y.; Wu, M.; Wang, Y.; Yao, J., Adv. Mater. 2019, 31 (17), 1807807.
6. Ahmad, T.; Liu, S.; Sajid, M.; Li, K.; Ali, M.; Liu, L.; Chen, W., Nano Res. Energy 2022, 1, e9120021.
7. Liang, J.; Zhang, C.; Liu, D.; Wu, T.; Tao, Y.; Ling, G.-W.; Yu, H.-J.; Lu, J.; Yang, Q.-H., Room-temperature reduction of NO2 in a Li—NO2 battery: a proof of concept. Science Bulletin 2020, 65 (1), 55.
8. Bae, S. W.; Roh, S. A.; Kim, S. D., Chemosphere 2006, 65 (1), 170.
9. Pappas, D. K.; Boningari, T.; Boolchand, P.; Smirniotis, P. G., J. Catal. 2016, 334, 1.
ADDIN EN.REFLIST 10. Kresse, G.; Furthmüller, J., Efficient iterative schemes for ab initio total-energy calculations using a plane-wave basis set. Phys. Rev. B 1996, 54 (16), 11169.
11. Kresse, G.; Joubert, D., From ultrasoft pseudopotentials to the projector augmented-wave method. Phys. Rev. B 1999, 59 (3), 1758.
12. Perdew, J. P.; Burke, K.; Ernzerhof, M., Generalized gradient approximation made simple. Phys. Rev. Lett. 1996, 77 (18), 3865.
13. Grimme, S.; Antony, J.; Ehrlich, S.; Krieg, H., A consistent and accurate ab initio parametrization of density functional dispersion correction (DFT-D) for the 94 elements H—Pu. J. Chem. Phys. 2010, 132 (15), 154104.
14. Grimme, S.; Ehrlich, S.; Goerigk, L., Effect of the damping function in dispersion corrected density functional theory. J. Comput. Chem. 2011, 32 (7), 1456-1465.
15. Jain, A.; Ong, S. P.; Hautier, G.; Chen, W.; Richards, W. D.; Dacek, S.; Cholia, S.; Gunter, D.; Skinner, D.; Ceder, G.; Persson, K. A., Commentary: The Materials Project: A materials genome approach to accelerating materials innovation. APL Materials 2013, 1 (1), 011002.
16. Himmetoglu, B.; Wentzcovitch, R. M.; Cococcioni, M., First-principles study of electronic and structural properties of CuO. Phys. Rev. B 2011, 84 (11), 115108.
17. Tang, W.; Sanville, E.; Henkelman, G., A grid-based Bader analysis algorithm without lattice bias. J. Phys.: Condens. Matter 2009, 21 (8), 084204.
18. Nørskov, J. K.; Rossmeisl, J.; Logadottir, A.; Lindqvist, L.; Kitchin, J. R.; Bligaard, T.; Jonsson, H., Origin of the overpotential for oxygen reduction at a fuel-cell cathode. J. Phys. Chem. B 2004, 108 (46), 17886-17892.
19. Ma, L.; Chen, S.; Pei, Z.; Huang, Y.; Liang, G.; Mo, F.; Yang, Q.; Su, J.; Gao, Y.; Zapien, J. A.; Zhi, C., ACS Nano 2018, 12 (2), 1949.
20. Chen, S.; Ma, L.; Wu, S.; Wang, S.; Li, Z.; Emmanuel, A. A.; Huqe, M. R.; Zhi, C.; Zapien, J. A., Adv. Funct. Mater. 2020, 30 (10), 1908945.
21. Sun, W.; Wang, F.; Zhang, B.; Zhang, M.; Kupers, V.; Ji, X.; Theile, C.; Bieker, P.; Xu, K.; Wang, C.; Winter, M., Science 2021, 371 (6524), 46.
22. Pan, J.; Xu, Y. Y.; Yang, H.; Dong, Z.; Liu, H.; Xia, B. Y., Adv. Sci. 2018, 5 (4), 1700691.
23. Shinde, S. S.; Jung, J. Y.; Wagh, N. K.; Lee, C. H.; Kim, D. H.; Kim, S. H.; Lee, S. U.; Lee, J. H., Nat. Energy 2021, 6 (6), 592.
24. Kim, J. H.; Lee, Y. H.; Cho, S J.; Gwon, J. G.; Cho, H. J.; Jang, M.; Lee, S. Y.; Lee, S. Y., Energy Environ. Sci. 2019, 12 (1), 177.
25. Ue, M.; Sakaushi, K.; Uosaki, K., Mater. Horiz. 2020, 7 (8), 1937.
26. Ma, L.; Li, N.; Long, C.; Dong, B.; Fang, D.; Liu, Z.; Zhao, Y.; Li, X.; Fan, J.; Chen, S.; Zhang, S.; Zhi, C., Adv. Funct. Mater. 2019, 29 (46), 1906142.
27. Cha, E.; Patel, M.; Bhoyate, S.; Prasad, V.; Choi, W., Nanoscale Horiz. 2020, 5 (5), 808-831.
28. Yuan, X.; Ma, F.; Zuo, L.; Wang, J.; Yu, N.; Chen, Y.; Zhu, Y.; Huang, Q.; Holze, R.; Wu, Y.; van Ree, T., Electrochem.l Energy Rev. 2021, 4 (1), 1.
29. Duhnen, S.; Betz, J.; Kolek, M.; Schmuch, R.; Winter, M.; Placke, T., Small Methods 2020, 4 (7), 2000039.
30. Jiang, J.; Sun, F.; Zhou, S.; Hu, W.; Zhang, H.; Dong, J.; Jiang, Z.; Zhao, J.; Li, J.; Yan, W.; Wang, M., Nat. Commun. 2018, 9 (1), 2885.
31. Zhao, S.; Tan, C.; He, C. T.; An, P.; Xie, F.; Jiang, S.; Zhu, Y.; Wu, K. H.; Zhang, B.; Li, H.; Zhang, J.; Chen, Y.; Liu, S.; Dong, J.; Tang, Z., Nat. Energy 2020, 5 (11), 881.
32. Chen, G. F.; Ma, T. Y.; Liu, Z. Q.; Li, N.; Su, Y. Z.; Davey, K.; Qiao, S. Z., Adv. Funct. Mater. 2016, 26 (19), 3314.
33. Doan, H.; Kendrick, I.; Blanchard, R.; Jia, Q.; Knecht, E.; Freeman, A.; Jankins, T.; Bates, M. K.; Mukerjee, S., J. Electrochem. Soc. 2021, 168 (8), 084501.

What is claimed is:

1. A rechargeable aqueous Zn∥NO₂ cell comprising:
an anode;
a gas diffusion cathode formed by at least one nano NiO catalyst-deposited material and located under a gas source, wherein the nano-NiO catalyst exhibits an electrocatalytic performance of at least 350 mV for overpotential at 10 mA·cm⁻², and the nano-NiO catalyst exhibits a Tafel slope lower than 65 mV·dec⁻¹;
a separator placed between the gas diffusion cathode and the anode; and
an electrolyte disposed in a space between the gas diffusion cathode and the anode,
wherein the rechargeable aqueous Zn∥NO₂ cell delivers a high specific capacity of at least 800 mAh·g⁻¹ with an output voltage of 1.79 V at 0.2 mA·cm⁻², and when the current increased up to 20 mA·cm⁻², the rechargeable aqueous Zn∥NO₂ cell delivers a high capacity of at least 700 mAh·g⁻¹ with at least 90% capacity retention.

2. The rechargeable aqueous Zn∥NO₂ cell of claim 1, wherein the anode comprises Zn foil or Zn plate.

3. The rechargeable aqueous Zn∥NO₂ cell of claim 1, wherein the electrolyte comprises ZnCl₂ solution, Zn(OTf)₂ solution, ZnSO₄ solution, or KOH solution, or a combination thereof.

4. The rechargeable aqueous Zn∥NO₂ cell of claim 1, wherein the separator comprises polypropylene/polyethylene/polypropylene (PP/PE/PP) separator, poly(tetrafluoroethylene) (PTFE), poly(vinyl chloride) (PVC) and polyamide (PA).

5. The rechargeable aqueous Zn∥NO₂ cell of claim 1, wherein the at least one nano NiO catalyst-deposited material comprises carbon fiber cloth (CFC), a fluorocarbon-based polymer, or isopropanol.

6. The rechargeable aqueous Zn∥NO₂ cell of claim 1, wherein a device having the nano NiO catalyst exhibits a high open circuit voltage (OCV) of at least 1.8 V under NO₂ atmosphere.

7. The rechargeable aqueous Zn∥NO₂ cell of claim 1, wherein the rechargeable aqueous Zn∥NO₂ cell has a peak power density of at least 80 mW·cm⁻².

8. The rechargeable aqueous Zn∥NO₂ cell of claim 1, wherein the gas source is NO₂.

9. The rechargeable aqueous Zn∥NO₂ cell of claim 8, wherein the rechargeable aqueous Zn∥NO₂ cell works with at least 3 vol. % NO₂ gas diffusing.

10. The rechargeable aqueous Zn∥NO₂ cell of claim 1, wherein the gas diffusion cathode is based on the NO₂/NO₂⁻ redox reaction.

11. The rechargeable aqueous Zn∥NO₂ cell of claim 1, wherein the rechargeable aqueous Zn∥NO₂ cell is of Ah-scale.

12. The rechargeable aqueous Zn∥NO₂ cell of claim 1, wherein the rechargeable aqueous Zn∥NO₂ cell delivers a high energy density of at least 553.2 Wh·kg⁻¹_{cell} and a high volumetric density of 1589.6 Wh·L⁻¹_{cell}.

13. The rechargeable aqueous Zn∥NO₂ cell of claim 1, wherein the rechargeable aqueous Zn∥NO₂ cell demonstrates cycling stability over 100 h at a current density of 5 mA·cm⁻² with a charge or discharge time of 1 h, and the energy efficiency reaches at least 80%.

14. A self-powered Haber-Bosch reactor for NH₃ production, comprising a graphite bipolar plate, an ion exchange membrane, a TiO₂/CFC electrode, and at least two rechargeable aqueous Zn∥NO₂ cells of claim 1 connected in series to drive the subsequent electrocatalytic reduction for NH₃ synthesis.

15. The self-powered Haber-Bosch reactor of claim 14, wherein with the duration extended, the voltage maintains 3.0 V unchanged and the output current is approximately 2.1 mA·cm⁻² over 8 h.

16. The self-powered Haber-Bosch reactor of claim 14, wherein the self-powered Haber-Bosch reactor has a self-powered NH₃ yield of at least 4 mM·h⁻¹ per hour by measuring solution volume involved in the cathode reaction.
